(19) United States
(12) Patent Application Publication
(10) Pub. No.: US 2015/0348187 A1
(43) Pub. Date: Dec. 3, 2015

(54) SYSTEMS AND METHODS FOR DETERMINING OCCUPANCY

(71) Applicant: LexisNexis Risk Solutions Inc., Alpharetta, GA (US)

(72) Inventors: Heather Michelle Way McCarl, St. Paul, MN (US); James Alan Christiansen, Chanhassen, MN (US); Brent Wayne Sorenson, Prior Lake, MN (US); Michael James Woodberry, Bozeman, MT (US)

(73) Assignee: LexisNexis Risk Solutions Inc., Alpharetta, GA (US)

(21) Appl. No.: 14/290,111

(22) Filed: May 29, 2014

(51) Int. Cl. G06Q 40/02

(52) U.S. Cl. CPC G06Q 40/025; G06Q 40/08

(57) ABSTRACT

Certain implementations may include systems and methods for determining occupancy. According to an example implementation, a method is provided. The method includes receiving identifying information related to occupancy of a target property by a subject. The identifying information may include a name of the subject and an address of the target property. In certain embodiments, the identifying information may include an actual or approximate investigation date to allow a historical evaluation of occupancy at a specific time in the past. The method includes querying one or more public or private databases with the identifying information and receiving, in response to the querying, subject and property information. The method includes determining one or more indicators of occupancy of the target property. The method includes determining, with the one or more computer processors, a score based on the one or more indicators of occupancy; and outputting an indication of the score.

### BACKGROUND

Real estate sales transactions typically involve legal contracts and agreements to satisfy requirements of the seller, the buyer, the mortgage lender, the property insurance provider, and/or other involved parties. The property being purchased is generally identified by a street address, and the buyer and/or the seller are typically listed by name. Insurance companies understand that certain risks associated with a property may be reduced when an owner occupies a property, and in some instances, the buyer of the property may receive a lower mortgage interest rate and/or a lower property insurance rate if they actually maintain residence at the property. For example, if a water pipe bursts, an owner living at the property may know where to turn off a water main, and he or she may be motivated to act quickly to reduce further water damage to the property. Conversely, renters or other individuals occupying the property may not be able or willing to respond appropriately. Furthermore, certain insurance companies may take steps to cancel a homeowner's policy due to the increased risk of vandalism and/or theft, for example, if the property is unoccupied for longer than predetermined period. The need exists to determine occupancy of a property.

### SUMMARY

Some or all of the above needs may be addressed by certain implementations of the disclosed technology. Certain implementations may include systems and methods for determining occupancy.

According to an example implementation, a method is provided. The method includes receiving identifying information related to occupancy of a target property by a subject. The identifying information includes a name of the subject and an address of the target property. The method includes querying one or more public or private databases with the identifying information and receiving, in response to the querying, subject and property information that may include, as applicable one or more of: utility records; evidence of commercial transaction behavior by the subject; credit bureau records; property deed and tax assessment records; public records; public records of relatives; addresses of relatives; and address history of relatives. The method includes determining, with one or more computer processors, based at least in part on the received subject and property information, one or more indicators of occupancy of the target property. The one or more indicators may include, as applicable, one or more of: an indication of activity at an address of a second property by a previous resident of the target property; an indication of activity verifying the subject occupancy at the target property; and/or an indication of activity verifying non-occupancy by the subject at a previous address associated with the subject. The method further includes determining, with the one or more computer processors, a score based on the one or more indicators of occupancy; and outputting an indication of the score.

According to another example implementation, a system is provided. The system includes a memory for storing data and computer-executable instructions; and at least one processor configured to access the memory, wherein the at least one processor is further configured to execute the computer-executable instructions to cause the system perform a method, which includes receiving identifying information related to occupancy of a target property by a subject. The identifying information includes a name of the subject and an address of the target property. The method further includes querying one or more public or private databases with the identifying information and receiving, in response to the querying, subject and property information that may include, as applicable one or more of: utility records; evidence of commercial transaction behavior by the subject; credit bureau records; property deed and tax assessment records; public records; public records of relatives; addresses of relatives; and address history of relatives. The method includes determining, with one or more computer processors, based at least in part on the received subject and property information, one or more indicators of occupancy of the target property. The one or more indicators may include, as applicable, one or more of: an indication of activity at an address of a second property by a previous resident of the target property; an indication of activity verifying the subject occupancy at the target property; and/or an indication of activity verifying non-occupancy by the subject at a previous address associated with the subject. The method further includes determining, with the one or more computer processors, a score based on the one or more indicators of occupancy; and outputting an indication of the score.

According to another example implementation, a non-transient computer-readable medium is provided for storing instructions, that when executed by a user device having one or more processors, cause the one or more processors to perform a method. The method includes receiving identifying information related to occupancy of a target property by a subject. The identifying information includes a name of the subject and an address of the target property. The method includes querying one or more public or private databases with the identifying information and receiving, in response to the querying, subject and property information that may include, as applicable one or more of: utility records; evidence of commercial transaction behavior by the subject; credit bureau records; property deed and tax assessment records; public records; public records of relatives; addresses of relatives; and address history of relatives. The method includes determining, with one or more computer processors, based at least in part on the received subject and property information, one or more indicators of occupancy of the target property. The one or more indicators may include, as applicable, one or more of: an indication of activity at an address of a second property by a previous resident of the target property; an indication of activity verifying the subject occupancy at the target property; and/or an indication of activity verifying non-occupancy by the subject at a previous address associated with the subject. The method further includes determining, with the one or more computer processors, a score based on the one or more indicators of occupancy; and outputting an indication of the score.

Other implementations, features, and aspects of the disclosed technology are described in detail herein and are considered a part of the claimed disclosed technology. Other implementations, features, and aspects can be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 is a block diagram of an illustrative process 100 for determining occupancy, according to an example implementation.

FIG. 2 is an illustrative block diagram of a system 200, according to an example implementation.

FIG. 3 is a block diagram of illustrative information 300 utilized for determining occupancy, according to an example implementation of the disclosed technology.

FIG. 4 is a flow diagram of a method 400, according to an example implementation.

### DETAILED DESCRIPTION

Some implementations of the disclosed technology will be described more fully hereinafter with reference to the accompanying drawings. This disclosed technology may, however, be embodied in many different forms and should not be construed as limited to the implementations set forth herein.

In the following description, numerous specific details are set forth. However, it is to be understood that implementations of the disclosed technology may be practiced without these specific details. In other instances, well-known methods, structures and techniques have not been shown in detail in order not to obscure an understanding of this description. References to “one implementation,” “an implementation,” “example implementations,” “various implementations,” “certain implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Certain implementations of the disclosed technology may enable interested parties to estimate the likelihood that a subject (such as an owner or other entity associated with a residence) is actually occupying and/or living at a particular residence. According to certain example implementations of the disclosed technology, basic information such as the subject's name and the property street address may be utilized to query one or more public or private databases to obtain subject and property information. In certain example implementations, an investigation date may be specified with time or date in the past, for example, to allow a historical evaluation of occupancy. Certain implementations of the disclosed technology may analyze the subject and property information, not only from the perspective of the subject of interest, but also from the perspective of other persons who have lived at the property previously, for example, to detect activities indicative of the previous occupier moving to a new residence. Certain embodiments of the disclosed technology may analyze related information, such as utility connects, disconnects, and associated addresses and names to detect such activities.

Computer-implemented systems and methods are disclosed herein to obtain and process subject and property information to estimate the likelihood of occupancy of a particular residence property by a particular subject. In certain example implementations of the disclosed technology, indicators of occupancy may be determined from available public and/or private information that may indicate whether the subject moved in to the residence, whether a previous resident moved out of the residence, whether the subject moved out of a prior residence, whether someone other than the subject moved in to the residence, whether activities of the subject are indicative of occupancy of the residence, and/or whether the activities of the subject are indicative of occupancy of another residence. In certain example implementations of the disclosed technology, public and/or private information may be utilized to determine if the residence property is a newly built structure, and in such cases, the detection of a previous resident moving out may not be relevant.

Certain embodiments of the disclosed technology may also utilize public and/or private information to detect certain activities of relatives or associates of a particular subject that may be relevant to the detection of occupancy.

Various identifying information may be utilized to retrieve related public and/or private records, and such records may be analyzed to determine occupancy, according to example implementations of the disclosed technology, and will now be described with reference to the accompanying figures.

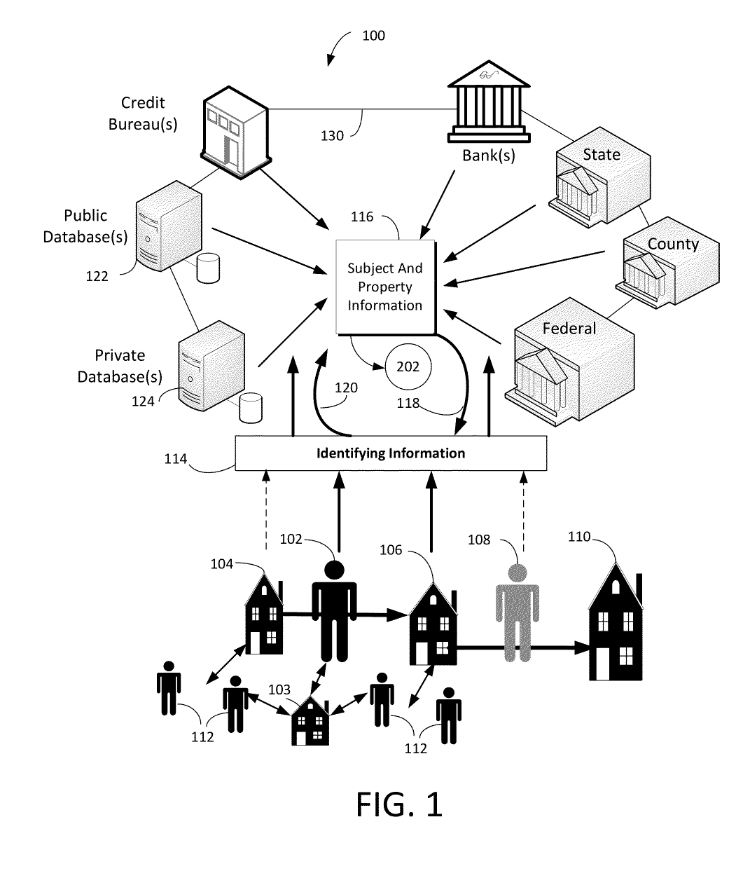

FIG. 1 illustrates a block diagram of an example process 100 for determining occupancy of a particular residence by a particular subject 102. As illustrated, a subject 102 may take ownership of a particular residence 106 (hereinafter, designated as a target property 106), for example, and the subject 102 may move into the target property 106 after moving out of a previous residence 104. In certain cases, a previous occupier or resident 108 of the target property 106 may move out of the target property 106 and into a second property 110. According to certain example embodiments, the subject 102, relatives, or associates 112 may also be involved or associated with a third property 103. For example, the third property 103 could be a rental property, a previous address, an address of relatives or associates 112, etc.

In an example implementation, identifying information 114, such as the name of the subject 102 and an address of the target property 106 may be sufficient to begin the process of determining occupancy of the property 106 by the subject 102. In another example implementation, the identifying information 114 associated with the target property 106 may include an actual or approximate move-in date to specify the date in which the subject 102 first occupied the target property 106. According to certain example embodiments, utility service disconnects and/or other information may be used to corroborate that the subject 102 actually moved out of the previous residence 104, and/or that the previous occupier 108 moved out of the target property 106.

In accordance with an example implementation of the disclosed technology, the one or more public database(s) 122 and/or the private database(s) 124 may store and/or consolidate information from other sources, such as credit bureaus, banks, governmental entities, etc. In certain example embodiments, querying the one or more public database(s) 122 and/or the private database(s) 124 may include querying these other sources. In certain embodiments, the one or more public database(s) 122 and/or the private database(s) 124 may request and receive updated information from the various information sources (credit bureaus, banks, governmental entities, etc.) via one or more communication channels 130.

According to an example implementation of the disclosed technology, various records may be utilized to obtain certain subject and property information 116. Such information may be derived from drivers license information, vehicle registration information, utility information, voting information, criminal information, court information, property deed and tax assessment records, other deed information, assessment information, other tax information, sales information, insurance information, etc.

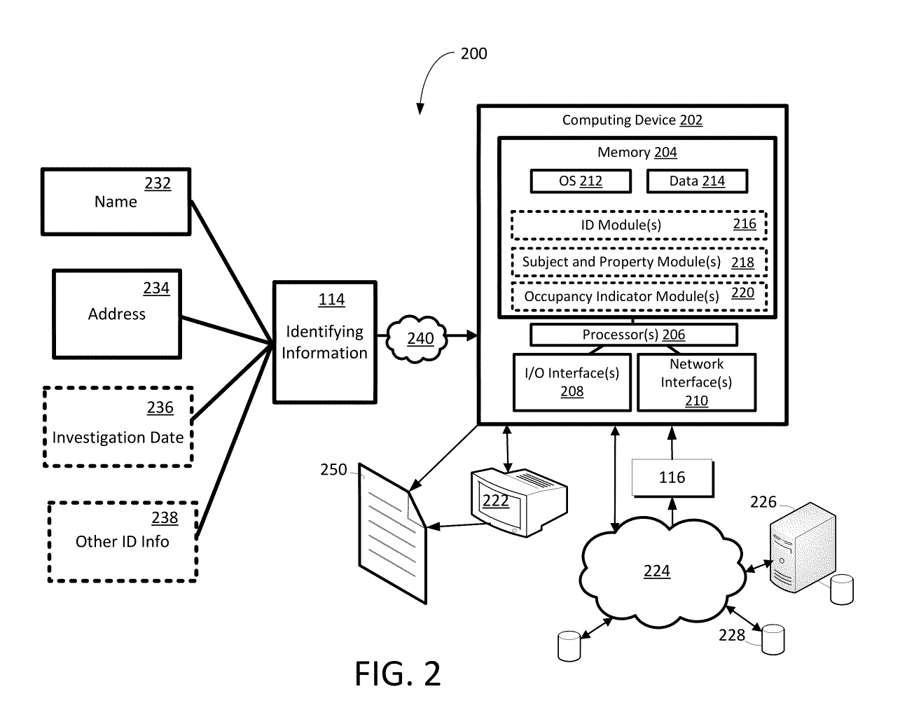

According to an example implementation of the disclosed technology, and in response to the querying the one or more public database(s) 122 and/or the private database(s) 124 with the identifying information 114, subject and property information 116 may be returned for further analysis, for example, to determine one or more indicators of occupancy (for example, by an computing device 202, as will be described below with reference to FIG. 2).

In an example implementation, the returned subject and property information 116 can include as applicable, one or more of the utility records, evidence of commercial transaction behavior by the subject 102 (which may include credit seeking behavior), credit bureau records, property deed and tax assessment records, public records, public records of relatives or associates 112, addresses of relatives or associates 112; and address history of relatives or associates 112. In certain example implementations, the returned subject and property information 116 can further include, as applicable, records of one or more events associated with the address of the target property 106 after the investigation date, one or more current activities associated with the subject 102 at the address of the target property 106, one or more current activities associated with the subject 102 or relatives or associates 112 at a third property 103 having an address that differs from the address of the target property 106, and/or one or more activities of relatives or associates 112 of the subject 102 at the address of the target property 106.

In accordance with an example implementation of the disclosed technology, the one or more indicators of occupancy may provide answers to one or more occupancy-related questions, including but not limited to:
Did the subject 102 move in to the target property 106?
Did a 3rd party or previous resident 108 move out of the target property 106?
Did the subject 102 move-out of a prior residence 104?
Did someone else move into the target property 106?
Are there resident-type activities associated with the subject 102 at an address that differs from the address of the target property 106?
Are there current resident-type activities associated with the subject 102 at the address of the target property 106?
Did the subject 102 update their driver's license information with the address of the target property 106?
Is the target property 106 a newly built residence?

In certain example implementations of the disclosed technology, the answers to the abovementioned occupancy-related questions, alone or in combination with the other indicators of occupancy, may be scored to provide an indication of occupancy of a particular property by a particular subject.

FIG. 2 depicts an illustrative block diagram of a system 200 for determining indicators of occupancy, according to an example implementation of the disclosed technology. The system 200, for example, may be utilized to receive identifying information 114; (process and) use the identifying information 114 to query one or more databases 226 228 via a network, Internet, or cloud 224; receive subject and property information 116 in response to the query; and determine one or more indicators of occupancy (for example, by the occupancy indicator module 220) from the received subject and property information 116.

According to an example implementation of the disclosed technology, the identifying information 114 may be utilized as input, and may include a name 232 of a subject (for example, the subject 102 as depicted in FIG. 1) and an address 234 of a residence or property (for example the target property 106 of FIG. 1). In certain example implementations, the identifying information 114 may include a move-in date. In certain example implementations, the identifying information may include other identifying information 238, such as a social security number, birth date, etc., for example, to refine the query or improve the returned subject and property information 116.

According to an example implementation, an investigation date 236 may be considered in the occupancy analysis. For example, in certain embodiments, the investigation date may be a specific time or date in the past to allow a historical evaluation of occupancy. In certain example implementations, the investigation date may include range of dates, for example, to capture activity within the range of dates.

In accordance with an example implementation of the disclosed technology, the computing device 202 may include one or more memory(s) 204 (such as RAM, ROM, hard drive storage, etc.), one or more processor(s) 206, an in/out interface 208, and a network interface 210. In an example implementation, the memory 204 may be configured to load an operating system 212 and data. The memory 204 may include one or more modules for processing the data 214. In one example implementation, the memory may include an ID module 216, for example, to format the received identifying information 114 appropriately for the query. In an example implementation, the memory 204 may include a subject and property module 218, for example, to determine if adequate information is returned from the query to be able to score the results with a given confidence.

In an example implementation, the memory may include an occupancy indicator module 220 for determining as applicable, one or more of an indication of activity at an address of a second property 110 by a previous resident 108 of the target property 106, an indication of activity verifying the subject 102 occupancy at the target property 106, an indication of activity verifying non-occupancy by the subject 102 at a previous address 104 associated with the subject 102; and determining, with the one or more computer processors 206, a score 250 based on the one or more indicators of occupancy. The score 250, for example, may represent the likelihood that the subject 102 is actually occupying the target property 106.

According to an example implementation of the disclosed technology, the score 250 determined by the occupancy indicator module 220 may be output, for display on one or more displays 222.

Certain aspects of FIG. 2 may be embodied in non-transitory computer readable media for execution by a processor 206. It will be understood that the computing device 202 is provided for example purposes only and does not limit the scope of the various implementations disclosed herein. In certain example implementations, The computing device 202 includes a central processing unit (CPU) 206, where computer instructions are processed; a display or in/out interface 208 that acts as a communication interface and provides functions for rendering video, graphics, images, and texts on a display 222. In certain example implementations of the disclosed technology, the in/out interface 208 may be directly connected to a local display 222. In another example implementation, the a network interface 210 may be configured for providing data, images, and other information for an external/remote display that is not necessarily physically connected to the computing device 202. For example, a desktop monitor may be utilized for mirroring graphics and other information that is presented on a mobile computing device.

In an example implementation, the network interface 210 may be configured as a communication interface and may provide functions for rendering video, graphics, images, text, other information, or any combination thereof on the local display 222 or any remote display. In one example, the in/out interface 208 may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof.

According to an example implementation of the disclosed technology, the computing device 202 may be configured to use an input device via one or more of in/out interfaces 208 (for example, a keyboard interface, a display interface, camera interface, sound interface, etc.,) to allow a user to capture information into the computing device 202. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device 202 or may be a separate device. For example, the input device may be an accelerometer, a magnetometer, a digital camera, a microphone, and an optical sensor.

Example implementations of the computing device 202 may include an antenna interface that provides a communication interface to an antenna; a network interface 210 that provides a communication interface to a network 224. In certain implementations, a sound interface is provided as a communication interface for converting sound into electrical signals using a microphone and for converting electrical signals into sound using a speaker. According to example implementations, a random access memory (RAM) is provided, where computer instructions and data may be stored in a volatile memory 204 device for processing by the one or more processors 206.

According to an example implementation, the computing device 202 includes a read-only memory (ROM) where invariant low-level system code or data for basic system functions such as basic input and output (I/O), startup, or reception of keystrokes from a keyboard are stored in a non-volatile memory device. According to an example implementation, the computing device 202 includes a storage medium or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 212, application programs (including, for example, a web browser application, a widget or gadget engine, and or other applications, as necessary) and data files 214 are stored. According to an example implementation, the computing device 202 includes a power source that provides an appropriate alternating current (AC) or direct current (DC) to power components. According to an example implementation, the computing device 202 includes and a telephony subsystem that allows the device 202 to transmit and receive sound over a telephone network. The constituent devices and the one or more processors 206 may communicate with each other over a bus.

In accordance with an example implementation, the processor 206 has appropriate structure to be a computer processor. In one arrangement, the processor 206 may include more than one processing unit. The storage medium part of the memory 204 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow the device 202 to access computer-executable process steps, application programs and the like, stored on removable and non-removable memory media, to off-load data from the device 202 or to upload data onto the device 202. A computer program product, such as one utilizing a communication system may be tangibly embodied in storage medium, which may comprise a machine-readable storage medium.

According to one example implementation, the term computing device, as used herein, may be a CPU, or conceptualized as a CPU (for example, the processor(s) 206 of FIG. 2). In this example implementation, the computing device 202 may be coupled, connected, and/or in communication with one or more peripheral devices, such as display 222. In another example implementation, the term computing device, as used herein, may refer to a mobile computing device, such as a smartphone or tablet computer. In this example embodiment, the computing device may output content to its local display and/or speaker(s). In another example implementation, the computing device may output content to an external display device (e.g., over Wi-Fi) such as a TV or an external computing system.

Various implementations of the communication systems and methods herein may be embodied in non-transitory computer readable media for execution by a processor. An example implementation may be used in an application of a mobile computing device, such as a smartphone or tablet, but other computing devices may also be used, such as to portable computers, tablet PCs, Internet tablets, PDAs, ultra mobile PCs (UMPCs), etc.

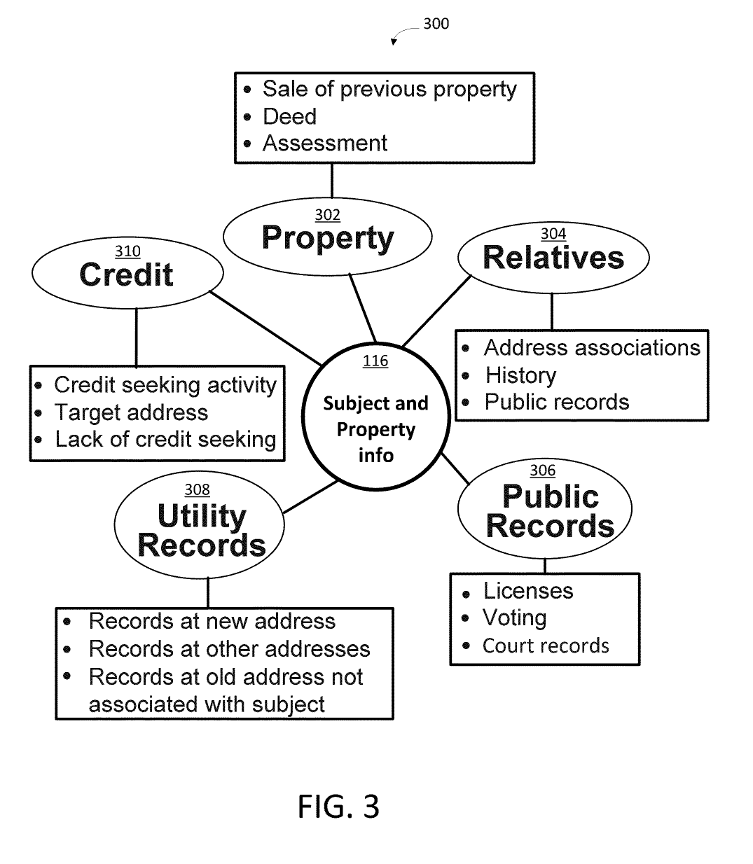

FIG. 3 depicts a block diagram of illustrative information 300 utilized for determining occupancy, according to an example implementation of the disclosed technology. For example, the subject and property information 114 may be derived from, or may include various records such as: property deed and tax assessment records 302, records of relatives or associates 304, public records 306, utility records 308, and/or credit records 310. For example, the property deed and tax assessment records 302 may include information such a sale of a previous property, purchase of a new property, deed information, assessment information, etc. In certain example implementations, the records of relatives or associates 304 may include address associations of a subject with relatives or associates, an address history of the subject's relatives, various public records that identify relatives, etc. In accordance with an example implementation of the disclosed technology, public records 308 may include information such as professional and business license information, voter registration information, court records, births, marriages, deaths, employment, driving records, criminal records, appraisal records, court dockets, etc.

In accordance with an example implementation of the disclosed technology, utility records 308 may include utility records associated with the various entities and addresses (such as the subject 102, the previous resident 108, and/or relatives or associates 112 as depicted in FIG. 1). In certain example implementations, the utility records 308 may be searched and/or processed, for example, to detect utility-related activity of the various entities at a new address or at an address not previously associated with a subject.

In accordance with an example implementation of the disclosed technology, commercial transactions for the subject 310 may be searched and/or processed to detect commercial transaction activity by the subject, and whether the commercial transaction activity is associated with the target property 106, a second property 110, a third property 103, or a previous property 104. Certain example implementations may further utilize the commercial transaction records 310 to determine if there is a lack of commercial transaction behavior.

In accordance with an example implementation of the disclosed technology, the illustrative information 300 as shown in FIG. 3 represents the type of information that may be included in the subject and property information 116, depending on the availability of the information. Those of skill in the art will recognize that not every subject and/or property will have the same information available, nor will they share the same circumstances, the same history, or even the same accuracy in the available information. Certain embodiments of the disclosed technology may score the indicators of occupancy to provide an indication of the likelihood that the subject is occupying a particular residence. Certain example implementations may also provide an additional score or grading to indicate the confidence of the output score, for example, based on the quality and/or quantity of the subject and property information that is returned.

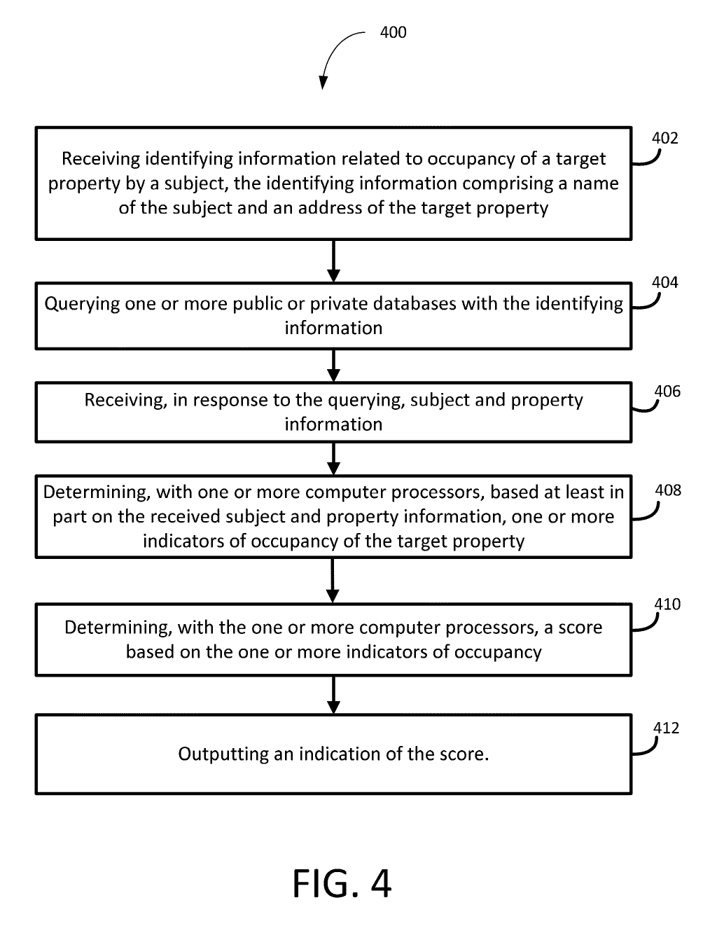

An example method 400 for determining occupancy will now be described with reference to the flowchart of FIG. 4. The method 400 starts in block 402, and according to an example implementation includes receiving identifying information related to occupancy of a target property by a subject, the identifying information comprising a name of the subject and an address of the target property. In block 404, the method 400 includes querying one or more public or private databases with the identifying information. In block 406, the method 400 includes receiving, in response to the querying, subject and property information. In block 408, the method 400 includes determining, with one or more computer processors, based at least in part on the received subject and property information, one or more indicators of occupancy of the target property. In block 410, the method 400 includes determining, with the one or more computer processors, a score based on the one or more indicators of occupancy. In block 412, the method 400 includes outputting an indication of the score.

In accordance with an example implementation, the subject and property information may include, as applicable, one or more of: utility records, evidence of commercial transaction behavior by the subject, credit bureau records, property deed and tax assessment records, public records, addresses of relatives; and/or address history of relatives.

According to an example implementation, the indicators of occupancy of the target property may include, as applicable, one or more of: an indication of activity at an address of a second property by a previous resident of the target property, an indication of activity verifying the subject occupancy at the target property, and/or an indication of activity verifying non-occupancy by the subject at a previous address associated with the subject.

In certain example implementations of the disclosed technology, the indicators of occupancy may further include, as applicable, one or more of: an indication of address verification of the target property, an indication of address verification of the previous address associated with the subject, an indication that the target property includes new construction, and/or an indication that the target property was previously unoccupied.

In accordance with an example implementation, the subject and property information may further include, as applicable, one or more of: one or more events associated with the address of the target property as of the investigation date, one or more current activities associated with the subject at the address of the target property, one or more current activities associated with the subject at a third property having an address that differs from the address of the target property, and/or one or more activities of relatives or associates of the subject at the address of the target property.

According to an example implementation, public records may include, as applicable, one or more of: drivers license information, vehicle registration information, utility information, voting information, criminal information, and court information; and wherein the property deed and tax assessment records include one or more of deed information, assessment information, tax information, sales information, and insurance information.

In certain example implementations of the disclosed technology, an indication of activity at the address of the second property by the previous resident of the target property may include, as applicable, one or more of: commercial transaction activity associated with the address of the second property, property deed and tax assessment records associated with the address of the second property, utility records associated with the address of the second property, and/or public records associated with the address of the second property.

According to an example implementation, an indication of activity verifying the subject occupancy at the target property may include, as applicable, one or more of: utility records associated with the subject, utility records associated with the address of the target property, records of seeking credit associated with the address of the target property, property deed and tax assessment records associated with the address of the target property, public records associated with the address of the target property, and/or records of relatives of the subject that are associated with the target property.

In certain example implementations of the disclosed technology, an indication of activity verifying non-occupancy by the subject at a previous address associated with the subject may include, as applicable: a record of sale of the previous address associated with the subject, public records that are no longer reporting subject activities associated with the previous address; lack of subject commercial transaction behaviors associated by the subject at the previous address, utilities at the previous address that are not associated with the subject, and/or relatives no longer associated with the previous address.

According to an example implementation, the one or more indicators of occupancy of the target property may further include, as applicable, one or more of: an indication of address verification of the target property, an indication of address verification of the previous property occupied by the subject, an indication that the target property was previously unoccupied, an indication that the subject moved to the target property, an indication that the subject moved from a previous property having an address that differs from the address of the target property, and/or an indication that a previous occupier of the target property moved from the target property to a property having an address that differs from the address of the target property.

### Address Information Hygiene and Exclusions

According to an example implementation of the disclosed technology, it may be assumed that the identifying information 114 may include a valid name, address, etc. However, in certain embodiments, there may be issues with the identifying information that may result in faulty or no subject and property information 116 being returned in response to a query. For example, the address may be misspelled or so new that no records exist. In accordance with an example implementation, certain exclusions may be flagged or handled to, for example, remove misspelled addresses, invalid addresses, duplicate addresses, consolidate like addresses, consolidate dates, identify move-backs, and/or handle multiple distinct periods of residence for a single address. In certain example implementations of the disclosed technology, the address information may be cleaned and/or modified before performing the query. In another example implementation, the address information may be cleaned and/or modified after receiving back the subject and property information 116.

In accordance with certain example implementations, other exclusions may be flagged, such as records returned indicating no associated vehicle, property, voter, and driver's license records associated with the subject, combined with limited information such as a single source, single bureau, or single date in the public or private information that is returned.

In certain example implementations of the disclosed technology, tie-breakers may be applied, for example, to emphasize or give extra weight to certain subject and property information. For example, information that may be emphasized may include the most recent first seen and last seen dates for the subject information; an adequate number of vehicle, voter, driver's license records and phone records with last name match; confirmed identity of a buyer on the current deed record and the mailing address matches property address; an adequate number of non-bureau reporting sources; an adequate number of sources overall; more than one bureau source; and at least one non-bureau source reporting. Thus, in certain aspects of the disclosed technology, the identifying information 114 and/or the returned subject and property information 116 may be cleaned and/or updated as needed.

### Occupancy Attributes and Indexes

In accordance with various example implementations of the disclosed technology, one or more processors (such as the processor(s) 206 in FIG. 2) may calculate an overall score, for example, to quantify the weight of evidence that a subject occupies a given address. Certain example implementations of the disclosed technology may return both occupancy attributes and indexes that score, weight, or otherwise, grade each of the occupancy attributes on scales indicative of occupancy. In certain example implementations, the indexes may be utilized to calculate an overall occupancy score indicating the weight of evidence that a given subject occupies a given address.

According to an example implementation, the occupancy attributes may include, or be based on one or more of:
address reporting source;
address reporting history;
address search history;
address utility history;
address ownership history;
address property type;
address validity;
relatives confirming address;
address owner mailing address;
prior address move;
prior resident move;
address date first seen;
address date last seen;
occupancy override;
inferred ownership type;
other owned property proximity; and/or
occupancy score.

According to various example implementations of the disclosed technology, each of the abovementioned occupancy attributes may be further indexed with scores. For example, the address reporting source may be identified by possible index values such as (−1) subject not found; (0) no sources reporting target address for subject; (1) target property is most recently reported by at least one confirming source of public records only; (2) target property is most recently reported by less than three credit header records but no public records; (3) target property is most recently reported by all three credit header records but no public records; (4) target property is most recently reported by at least one source of public records and less than three credit header records; and (5) target property is most recently reported by at least one source of public records and all three credit header records.

In accordance with an example implementation, the address reporting source may represent the level of evidence from credit bureau records and public record data that the target property is/was the most recently reported property by the confirming sources for the subject. In accordance with an example implementation, this attribute may be scored or indexed by calculating from highest value to lowest level. In certain example embodiments, public records may be defined as any of the following: voter registration, driver's license, watercraft registration, vehicle registration, aircraft registration, and all court records including derogatory public records. According to certain example implementations, public records may exclude property deed and tax assessment records for purposes of the address reporting source occupancy attribute.

In accordance with an example implementation, the address reporting history may represent the level of evidence that the target property is/was the most recently reported address and a uniquely reported address for the subject based on the input date. According to an example implementation, this attribute may be indexed from the weakest value (for example, a 1 may represent that the property is not updating for the subject and another address is updating) to the strongest value (for example, a 7 may represent that the property is the only updating address for the subject).

In accordance with an example implementation, the address search history may represent the level of evidence of commercial transaction behavior confirming that a target property is associated with the subject. In an example implementation, this attribute may be indexed from the weakest value (for example, a 0 may represent no account opening searches for the subject within the last year) to the strongest value (for example, a 6 may represent recent account opening searches confirming the target address for the subject).

In accordance with an example implementation, the address utility history may represent the level of evidence of existing utility services for the subject at the target property. For example this attribute may be indexed from the weakest value (for example, a 1 may represent multiple utility services associated with a different property) to the strongest value (for example, a 7 may represent multiple utility services associated only with the target property.

In accordance with an example implementation, the address ownership represents the level of evidence of the subject's ownership of the target property based on the address deed and tax records. In an example implementation, this attribute may be indexed from the weakest value (for example, 1 may represent that target property ownership is associated with unrelated individual(s)) to the strongest value (for example, a 5 may represent that the target property ownership is only associated with the subject or spouse).

In accordance with an example implementation, the address property type may represent the target property dwelling type. In an example implementation, this attribute may differentiate between business, PO Box, multi-family, single family, or other dwelling types.

In accordance with an example implementation, the address validity may identify property characteristics for the target property indicating the likelihood of address occupancy. In an example implementation, this attribute may be indexed and reported from the weakest value (for example, a 1 may represent an invalid property address) to the highest value (for example, a 4 may represent that the property address is valid).

In accordance with an example implementation, the relatives confirming address attribute may represent the level of evidence of subject first degree related or associated identities reporting at the target address. In certain embodiments, this attribute may be indexed and reported from the weakest value (for example, a 1 may represent that subject-related identities were previously associated with the target property but not any longer) to the strongest value (for example, a 4 may represent that the subject-related identities are currently found at the address).

In accordance with an example implementation, the address owner mailing address attribute may represent the level of evidence that the deed or tax assessment mailing address matches the target property address. In an example implementation, this attribute may be indexed and reported from the weakest value (for example, a 1 may represent that the deed and/or tax assessment mailing address and target property address do not match) to the strongest value (for example, a 6 may represent a match between the deed and/or tax assessment mailing address and target property address).

In accordance with an example implementation, the prior address move attribute may represents the level of evidence that the subject recently moved and therefore is more likely to reside at the target property. In an example implementation, this attribute may be indexed and reported from the weakest value (for example, a 1 may represents the subject owns their prior address with no evidence of movement) to the strongest value (for example, a 5 may represent that the subject sold his/her prior address).

In an example implementation, the prior resident move attribute may represent the level of evidence that the prior residents of the target property moved and therefore are unlikely to occupy the target property. In an example implementation, this attribute may be indexed and reported from the weakest value (for example, a 1 may represent that the prior residents own the property and show no evidence of movement) to the strongest value (for example, a 6 may represent that the prior residents sold target property and have bought a new property).

In an example implementation, the occupancy override attribute may represent whether evidence exists that the subject was deceased or incarcerated as of the input date.

In an example implementation, the inferred ownership type attribute represents the likely type of occupancy given that the subject owns the property. In an example implementation, this attribute may be indexed and reported from the weakest value (for example, a 1 may represent that the property is likely unoccupied) to the strongest value (for example, a 3 may represent that the property is likely a primary residence).

In an example implementation, the other owned property proximity attribute may represent the approximate distance in miles between the target property and the nearest additional property owned by the subject. This approximate value may be represented by index values representative of distance buckets of 0-10 miles, 10-50 miles, 50-100 miles, and over 100 miles away.

According to example implementations, certain technical effects can be provided, such as creating certain systems and methods that provide interested parties with a score indicating the likelihood that a particular subject is occupying a particular property or residence.

In example implementations of the disclosed technology, the computing device 202 may include any number of hardware and/or software applications that are executed to facilitate any of the operations. In example implementations, one or more I/O interfaces may facilitate communication between the computing device 202 and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device 202. The one or more I/O interfaces may be utilized to receive or collect data and/or user instructions from a wide variety of input devices. Received data may be processed by one or more computer processors as desired in various implementations of the disclosed technology and/or stored in one or more memory devices.

One or more network interfaces may facilitate connection of the computing device 202 inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems. As desired, implementations of the disclosed technology may include the computing device 202 with more or less of the components illustrated in FIG. 2.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, implementations of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A computer-implemented method comprising:
receiving identifying information related to occupancy of a target property by a subject, the identifying information comprising a name of the subject and an address of the target property;
querying one or more public or private databases with the identifying information;
receiving, in response to the querying, subject and property information comprising, as applicable, one or more of:
utility records;
evidence of commercial transaction behavior by the subject;
credit bureau records;
property deed and assessment records;
public records;
public records of relatives;
addresses of relatives; and
address history of relatives;
determining, with one or more computer processors, based at least in part on the received subject and property information, one or more indicators of occupancy of the target property comprising, as applicable, one or more of:
an indication of activity at an address of a second property by a previous resident of the target property;
an indication of activity verifying the subject occupancy at the target property;
an indication of activity verifying non-occupancy by the subject at a previous address associated with the subject; and
determining, with the one or more computer processors, a score based on the one or more indicators of occupancy; and
outputting an indication of the score.

2. The computer-implemented method of claim 1, wherein the indicators of occupancy further include, as applicable, one or more of:
an indication of address verification of the target property;
an indication of address verification of the previous address associated with the subject;
an indication that the target property includes new construction; and
an indication that the target property was previously unoccupied.

3. The computer-implemented method of claim 1, wherein receiving, in response to the querying, subject and property information further comprises, as applicable, one or more of:
one or more events associated with the address of the target property as of the investigation date;
one or more current activities associated with the subject at the address of the target property;
one or more current activities associated with the subject at a third property having an address that differs from the address of the target property; and
one or more activities of relatives or associates of the subject at the address of the target property or other properties.

4. The computer-implemented method of claim 1, wherein the public records include, as applicable, one or more of: drivers license information, vehicle registration information, utility information, voting information, criminal information, and court information; and wherein the property deed and tax assessment records include one or more of deed information, assessment information, tax information, sales information, and insurance information.

5. The computer-implemented method of claim 1, wherein an indication of activity at the address of the second property by the previous resident of the target property includes, as applicable, one or more of:
commercial transaction activity associated with the address of the second property;
property deed and tax assessment records associated with the address of the second property;
utility records associated with the address of the second property; and
public records associated with the address of the second property.

6. The computer-implemented method of claim 1, wherein an indication of activity verifying the subject occupancy at the target property includes, as applicable, one or more of:
utility records associated with the subject;
utility records associated with the address of the target property;
records of seeking credit associated with the address of the target property;
property deed and tax assessment records associated with the address of the target property;
public records associated with the address of the target property; and
records of relatives of the subject that are associated with the target property or other properties.

7. The computer-implemented method of claim 1, wherein an indication of activity verifying non-occupancy by the subject at a previous address associated with the subject includes, as applicable:
a record of sale of the previous address associated with the subject;
public records no longer reporting subject activities associated with the previous address;
lack of subject commercial transaction behaviors at the previous address;
utilities at the previous address not associated with the subject; and
relatives no longer associated with the previous address.

8. The computer-implemented method of claim 1, wherein determining the one or more indicators of occupancy of the target property further comprises, as applicable, one or more of:
an indication of address verification of the target property;
an indication of address verification of the previous property occupied by the subject;
an indication that the target property was previously unoccupied;
an indication that the subject moved to the target property;
an indication that the subject moved from a previous property having an address that differs from the address of the target property; and;
an indication that a previous occupier of the target property moved from the target property to a property having an address that differs from the address of the target property.

9. A system comprising:
a memory for storing data and computer-executable instructions; and
at least one processor configured to access the at least one first memory, wherein the at least one processor is further configured to execute the computer-executable instructions to cause the system perform a method comprising:
receiving identifying information related to occupancy of a target property by a subject, the identifying information comprising a name of the subject and an address of the target property;
querying one or more public or private databases with the identifying information;
receiving, in response to the querying, subject and property information comprising, as applicable, one or more of:
utility records;
evidence of commercial transaction behavior by the subject;
credit bureau records;
property deed and tax assessment records;
public records;
addresses of relatives; and
address history of relatives;
determining, with one or more computer processors, based at least in part on the received subject and property information, one or more indicators of occupancy of the target property comprising, as applicable, one or more of:
an indication of activity at an address of a second property by a previous resident of the target property;
an indication of activity verifying the subject occupancy at the target property;
an indication of activity verifying non-occupancy by the subject at a previous address associated with the subject; and
determining, with the one or more computer processors, a score based on the one or more indicators of occupancy; and
outputting an indication of the score.

10. The system of claim 9, wherein the indicators of occupancy further include, as applicable, one or more of:
an indication of address verification of the target property;
an indication of address verification of the previous address associated with the subject;
an indication that the target property includes new construction; and
an indication that the target property was previously unoccupied.

11. The system of claim 9, wherein receiving, in response to the querying, subject and property information further comprises, as applicable, one or more of:
one or more events associated with the address of the target property as of the investigation date;
one or more current activities associated with the subject at the address of the target property;
one or more current activities associated with the subject at a third property having an address that differs from the address of the target property; and
one or more activities of relatives or associates of the subject at the address of the target property.

12. The system of claim 9, wherein the public records include, as applicable, one or more of: drivers license information, vehicle registration information, utility information, voting information, criminal information, and court information; and wherein the property deed and tax assessment records include one or more of deed information, assessment information, tax information, sales information, and insurance information.

13. The system of claim 9, wherein an indication of activity at the address of the second property by the previous resident of the target property includes, as applicable, one or more of:
commercial transaction activity associated with the address of the second property;
property deed and tax assessment records associated with the address of the second property;
utility records associated with the address of the second property; and
public records associated with the address of the second property.

14. The system of claim 9, wherein an indication of activity verifying the subject occupancy at the target property includes, as applicable, one or more of:
utility records associated with the subject;
utility records associated with the address of the target property;
records of commercial transactions associated with the address of the target property;
property deed and tax assessment records associated with the address of the target property;
public records associated with the address of the target property; and
records of relatives of the subject that are associated with the target property.

15. The system of claim 9, wherein an indication of activity verifying non-occupancy by the subject at a previous address associated with the subject includes, as applicable:
a record of sale of the previous address associated with the subject;
public records no longer reporting subject activities associated with the previous address;
lack of subject commercial transaction behaviors at the previous address;
utilities at the previous address not associated with the subject; and
relatives no longer associated with the previous address.

16. The system of claim 9, wherein determining the one or more indicators of occupancy of the target property further comprises, as applicable, one or more of:
an indication of address verification of the target property;
an indication of address verification of the previous property occupied by the subject;
an indication that the target property was previously unoccupied;
an indication that the subject moved to the target property;
an indication that the subject moved from a previous property having an address that differs from the address of the target property; and;
an indication that a previous occupier of the target property moved from the target property to a property having an address that differs from the address of the target property.

17. A non-transient computer-readable medium storing instructions, that when executed by a user device having one or more processors, cause the one or more processors to perform a method comprising:
receiving identifying information related to occupancy of a target property by a subject, the identifying information comprising a name of the subject and an address of the target property;
querying one or more public or private databases with the identifying information;
receiving, in response to the querying, subject and property information comprising, as applicable, one or more of:
utility records;
evidence of commercial transaction behavior by the subject;
credit bureau records;
property deed and tax assessment records;
public records;
addresses of relatives; and
address history of relatives;
determining, with one or more computer processors, based at least in part on the received subject and property information, one or more indicators of occupancy of the target property comprising, as applicable, one or more of:
an indication of activity at an address of a second property by a previous resident of the target property;
an indication of activity verifying the subject occupancy at the target property;
an indication of activity verifying non-occupancy by the subject at a previous address associated with the subject; and
determining, with the one or more computer processors, a score based on the one or more indicators of occupancy; and
outputting an indication of the score.

18. The non-transient computer-readable medium of claim 17, wherein the indicators of occupancy further include, as applicable, one or more of:
an indication of address verification of the target property;
an indication of address verification of the previous address associated with the subject;
an indication that the target property includes new construction; and
an indication that the target property was previously unoccupied.

19. The non-transient computer-readable medium of claim 17, wherein receiving, in response to the querying, subject and property information further comprises, as applicable, one or more of:
one or more events associated with the address of the target property as of the investigation date;
one or more current activities associated with the subject at the address of the target property;
one or more current activities associated with the subject at a third property having an address that differs from the address of the target property; and
one or more activities of relatives or associates of the subject at the address of the target property.

20. The non-transient computer-readable medium of claim 17, wherein the public records include, as applicable, one or more of: drivers license information, vehicle registration information, utility information, voting information, criminal information, and court information; and wherein the property deed and tax assessment records include one or more of deed information, assessment information, tax information, sales information, and insurance information.

21. The non-transient computer-readable medium of claim 17, wherein an indication of activity at the address of the second property by the previous resident of the target property includes, as applicable, one or more of:
commercial transaction activity associated with the address of the second property;
property deed and tax assessment records associated with the address of the second property;
utility records associated with the address of the second property; and
public records associated with the address of the second property.

22. The non-transient computer-readable medium of claim 17, wherein an indication of activity verifying the subject occupancy at the target property includes, as applicable, one or more of:
utility records associated with the subject;
utility records associated with the address of the target property;
records of seeking credit associated with the address of the target property;
property deed and tax assessment records associated with the address of the target property;
public records associated with the address of the target property; and
records of relatives of the subject that are associated with the target property.

23. The non-transient computer-readable medium of claim 17, wherein an indication of activity verifying non-occupancy by the subject at a previous address associated with the subject includes, as applicable:
a record of sale of the previous address associated with the subject;
public records no longer reporting subject activities associated with the previous address;
lack of subject commercial transaction behaviors at the previous address;
utilities at the previous address not associated with the subject; and
relatives no longer associated with the previous address.

24. The non-transient computer-readable medium of claim 17, wherein determining the one or more indicators of occupancy of the target property further comprises, as applicable, one or more of:
an indication of address verification of the target property;
an indication of address verification of the previous property occupied by the subject;
an indication that the target property was previously unoccupied;
an indication that the subject moved to the target property;
an indication that the subject moved from a previous property having an address that differs from the address of the target property; and
an indication that a previous occupier of the target property moved from the target property to a property having an address that differs from the address of the target property.
